(19) United States
(12) Patent Application Publication
(10) Pub. No.: US 2015/0218750 A1
(43) Pub. Date: Aug. 6, 2015

(54) Embossing a Design on Fabrics

(71) Applicant: Alyssa Lesser, New York, NY (US)

(72) Inventor: Alyssa Lesser, New York, NY (US)

(21) Appl. No.: 14/169,530

(22) Filed: Jan. 31, 2014

(51) Int. Cl. D06Q 1/08; B29C 65/74; B29C 65/62; B44C 1/24

(52) U.S. Cl. CPC D06Q 1/08; B44C 1/24; B29C 65/74; B29C 65/62

(57) ABSTRACT

A method for producing an embossed pattern on a fabric sheet or a surface panel of a garment, and the final pattern piece made by this method. A fabric sheet is embossed with a pattern using an embossing die pair. A mesh interfacing sheet has resin elements fused to it in the same pattern by a similar embossing die pair. When the resin elements are in a pattern of singular, scattered motifs, the mesh interfacing sheet is cut in such a manner that all of the resin elements within the mesh interfacing piece are whole, and no resin elements touch or are close to the edges of the cut sheet. In the case of a continuous pattern, the closest distance between an edge of the mesh interfacing sheet and the final fabric pattern piece will be at least 0.5 inch. The cut mesh interfacing piece is aligned and fused with the embossed fabric piece, and the composite fabric piece is cut to make a final pattern piece. This method produces final pattern pieces that do not have resin material running into the portions that will be sewn to other fabric pieces. These final pattern pieces have a marginal area around the peripheral edges where there is no resin-filled elements and where a seam may be sewn. Thus, there will be no sewing of a seam through any of the resin-filled elements. As a result, pieces with raised embossing elements may be sewn to other pieces to construct a garment which appears to have continuous raised embossing elements.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

This invention pertains to textile and garment design, development, and creation. According to known methods and industrial techniques, it has been possible only to deeply emboss and fill singular designs or logos in one specific location on a garment. EP 87201464.2 discusses a method for embossing deep seals on leather or fabric, but does not discuss placement of these embossed seals in relation to the seam area of the garment. Thus far, no method has existed outlining how to emboss the entire surface panels of a garment, creating an all-over embossed design while still allowing for the seams of the garment to be sewn together. Known fabric embossing methods have not taken into account the fact that it is problematic and near-impossible to sew through embossed and filled fabric. In this invention, embossed composite fabric pieces are created with marginal areas that are free of resin-filled elements, to provide an area where the seams may be sewn when one or more embossed composite fabric piece is sewn into a garment. Thus, there is no sewing of seams through any of the embossed, resin-filled design portions.

### BRIEF SUMMARY OF THE INVENTION

This invention provides a method of embossing flexible fabric pieces, such as denim, in order to obtain a three-dimensional textured surface that appears to encompass an entire surface of a garment or the entire surface of a panel of a garment. The embossed three-dimensional textured surface of each fabric piece includes depressed areas and elevated areas. This new method outlines the procedures required to emboss designs in an all-over manner so that the garment or portions of the garment have a three-dimensional all-over printed motif. Once sewn together, the pieces outlined in this method appear to have an embossed, resin-filled pattern from edge to edge, but in actuality the unsewn pieces have a marginal area around their edges where there is no embossed, resin-filled pattern to allow for sewing of the pieces into a garment. This invention also takes into account seepage of embossing resin into the seam allowances of the pieces of the garment and either controls or eliminates this seepage so that the pieces can be sewn together properly into a garment.

### BRIEF DESCRIPTION OF THE SEVERAL VIEWS OF THE DRAWINGS

FIG. 1 is a plan view of an example of a matrix component of a die pair with a scattered motif polka dot design.

FIG. 2A is a plan view illustrating a fabric sheet on top of the matrix component of the embossing die pair in a step of the invention.

FIG. 2B shows a fabric sheet having embossed circles.

FIG. 2C shows a cross section of the fabric sheet shown in FIG. 2B per section lines 2C-2C therein with concave embossed circles on the top side of the fabric and convex embossed circles on the bottom side of the fabric.

FIG. 3A depicts a plan view of what a matrix component of a die pair with a scattered motif polka dot design will look like once the hollow embossing elements 2 are filled with resin material.

FIG. 3B illustrates a sheet of mesh interfacing with protruding resin embossing elements fused to the surface.

FIG. 3C shows a cross section of the interfacing sheet with fused resin embossing elements shown in 3B per section lines 3C-3C with protruding resin embossing elements.

FIG. 4A shows how an interfacing sheet fused with scattered, polka-dot resin embossing elements is cut down to a preliminary first pattern shape to eliminate all resin embossing elements from the potential seam area.

FIG. 4B shows the resin-fused mesh interfacing cut into a preliminary first pattern shape depicted in FIG. 4A overlaid on top of the corresponding embossed fabric sheet.

FIG. 4C shows an exploded, cross sectional view of FIG. 4B per section lines 4C-4C, of the resin-fused mesh interfacing cut into a preliminary first pattern shape overlaid onto the corresponding embossed fabric sheet.

FIG. 4D shows an example of the final composite first pattern piece depicted in FIG. 34B after it is pressed and cut, showing the marginal area without any resin filled embossing elements.

FIG. 5A shows how a mesh interfacing sheet with fused resin embossing elements in a continuous, striped design is cut down to eliminate all resin embossing elements from the potential seam area.

FIG. 5B shows the resin-fused mesh interfacing cut into a first pattern shape in the continuous striped design depicted in FIG. 5A overlaid on top of the corresponding embossed fabric sheet.

FIG. 5C illustrates an example of resin seepage from the edges of the embossing elements after the resin-fused mesh interfacing cut into a first pattern shape and the embossed fabric sheet as depicted in FIG. 5B are heated and pressed.

FIG. 5D shows an example of the final composite cut pattern piece depicted in FIG. 5B after it is pressed and cut.

### DETAILED DESCRIPTION OF THE INVENTION

The method outlined below explains how to emboss a flexible material piece in order to obtain a three-dimensional textured surface that appears to encompass an entire surface of a garment or the entire surface of a panel of a garment. A flexible material piece will typically be a fabric sheet made from a woven material such as denim, but it can be any other flexible material suitable for being embossed and being part of a garment. Embossing creates a three-dimensional texture on the surface of a fabric that includes depressed areas and elevated areas. “Fabrics” utilized in this process may be woven or not woven, and may include, for example, denim, leather, heavy cotton twill, or any woven fabric considered to have a substantial weight. This method outlines how to create an embossing design that stretches across at least the length or width of pattern pieces that may be sewn together into a garment which, while there is no sewing through any embossed, resin filled portions, appears to have a continuous design of embossed, resin-filled portions.

### First Embodiment

In a first embodiment, the method of the invention can produce an embossed pattern of singular, scattered motifs. The term motif is known to those of skill in the art to refer to individual design elements.

The method of the first embodiment will typically include the following steps:

Step 1) pressing a fabric sheet with a first embossing die pair having a punch component and a matrix component to form convex/concave elements in the fabric sheet, wherein the embossing die pair contains a pattern of singular, scattered motifs.

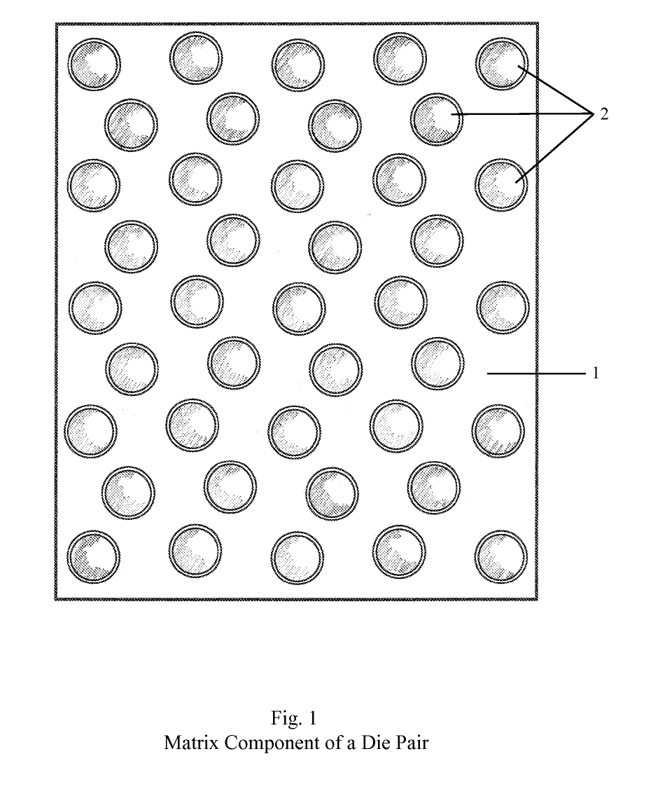

Die pairs for embossing are well known in the art. An embossing die pair contains a concave matrix plate with hollow elements and a convex punch plate with protruding elements, wherein both plates in the embossing die pair depict the same pattern. FIG. 1 illustrates an exemplary matrix plate 1 having hollow elements 2, in the shape of the motifs to be embossed. The convex punch plate (not illustrated) would have the complementary pattern of protruding elements.

The dimensions of the embossing die are not particularly limited, and will be determined by the sizes of the pattern pieces that will be made, as will be understood by one of skill in the art. In general, the die should be large enough to fully cover at least the width or length of the largest size pattern piece to be made. Typically, dimensions will be selected to maximize the size of die that can exist in an embossing heat press machine, and minimize the number of times the embossing must be done.

Embossing artwork depicted on the die pair may contain a pattern of motifs scattered over the entirety of the plates, from edge to edge, to create an all-over design. The pattern on the embossing die pair may also be engineered with a proper repeat so that the embossing design can, if need be, stamped twice either from side to side or from top to bottom on a sheet of fabric. In the first embodiment, the pattern on the die pair is a pattern with singular, scattered motifs. An embossing pattern with singular, scattered motifs contains individual motifs (such as polka dots) that are self-contained and small enough so that several of these motifs will occur across the die and do not extend across the entire width or length of the die (unlike a stripe or a plaid). A continuous embossing pattern (as described in the second embodiment) contains design elements that extend across a large portion of a die so that these design elements would extend across a large portion of a corresponding embossed fabric sheet. A continuous embossing pattern may be a stripe with spaces in between the design elements, or a plaid with intersecting elements. FIG. 1 illustrates an example of a matrix component of a die pair with a scattered motif polka dot design, matrix component 1 having multiple embossing motifs 2, which are hollow in the matrix component. The punch component will have the corresponding convex motifs, so that when a sheet of fabric is pressed between it, it is embossed with the corresponding pattern.

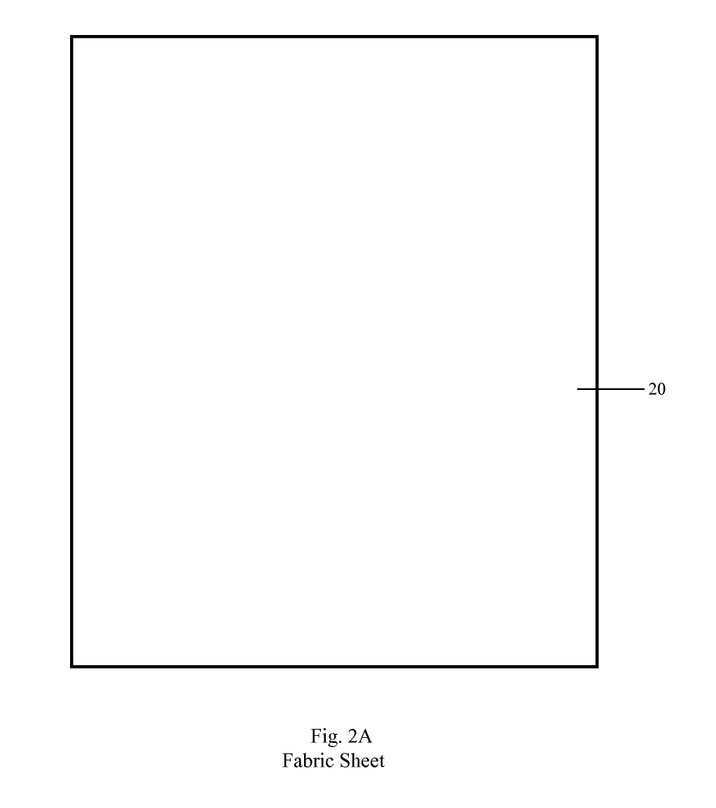

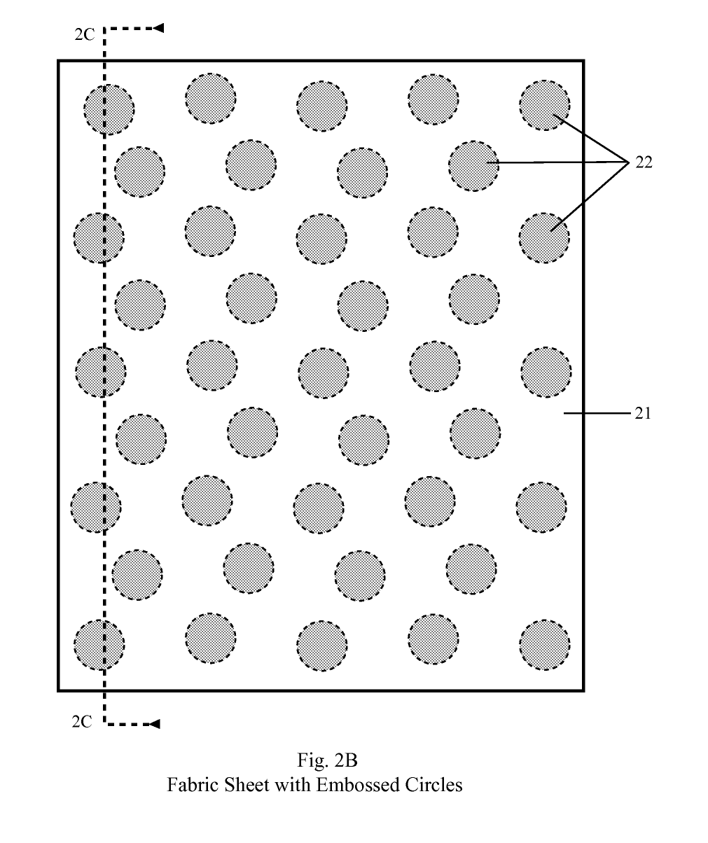

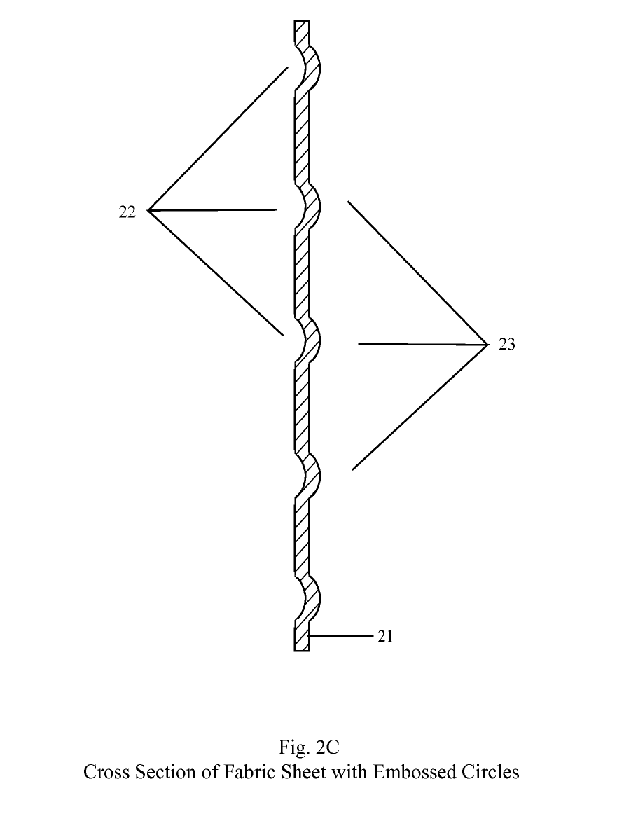

In the first step, a fabric sheet is placed over the matrix component of the embossing die. FIG. 2A illustrates an example of fabric sheet 20 on top of the exemplary matrix component 1 of the embossing die pair. The matrix embossing die is underneath the fabric sheet and not visible. The dimensions of the fabric sheet will be determined by the size of the pattern piece being prepared and the size of the embossing die. After the fabric sheet is stamped with an embossing pattern, it will then be used as the material from which the pattern piece of the garment will be cut. Fabric sheets may be engineered to maximize the number of pattern pieces that can fit on each sheet, and minimize the number of times the embossing must be done.

In the first step, the fabric sheet is pressed in between the embossing die pair. This may be done, for example, using procedures and temperatures known in the art such as those outlined in EP 87201464.2. If there is a long or irregular shaped pattern piece, such as a pant leg or sleeve that exceeds the dimensions of the embossing die, the corresponding fabric sheet may be stamped twice into the embossing heat press. Application of a second embossing pressing, if necessary, must not overlap any area of the first embossing, or it will form an undesirable crease in the fabric. A second embossing pressing should be applied directly below or next to the first stamp without overlapping.

FIG. 2B illustrates fabric sheet 21 after this step. The fabric sheet 21 can be seen having embossed concave elements 22, which are in the shape of the motif (in this example, circles). FIG. 2C shows a cross section of the embossed fabric sheet shown in FIG. 2B, illustrating the three-dimensionality of the embossing elements, with concave embossed circles 22 on one side of the fabric and convex embossed circles 23 on the opposite side of the fabric.

Step 2) adding resin material to substantially fill the hollow elements of a matrix component of a second embossing die pair having the same pattern as the first embossing die pair.

In step 2) a resin material is added to the hollow elements of the matrix component of an embossing die pair that has the same pattern as the embossing die pair used to press the fabric sheet. This die pair may be physically the same die pair used in step 1, although more typically another die pair will be used.

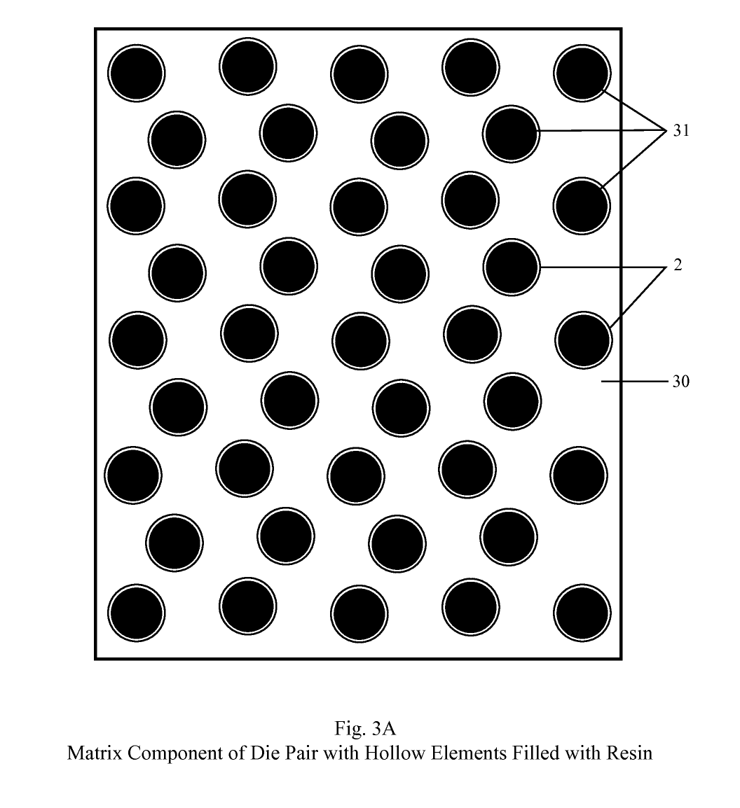

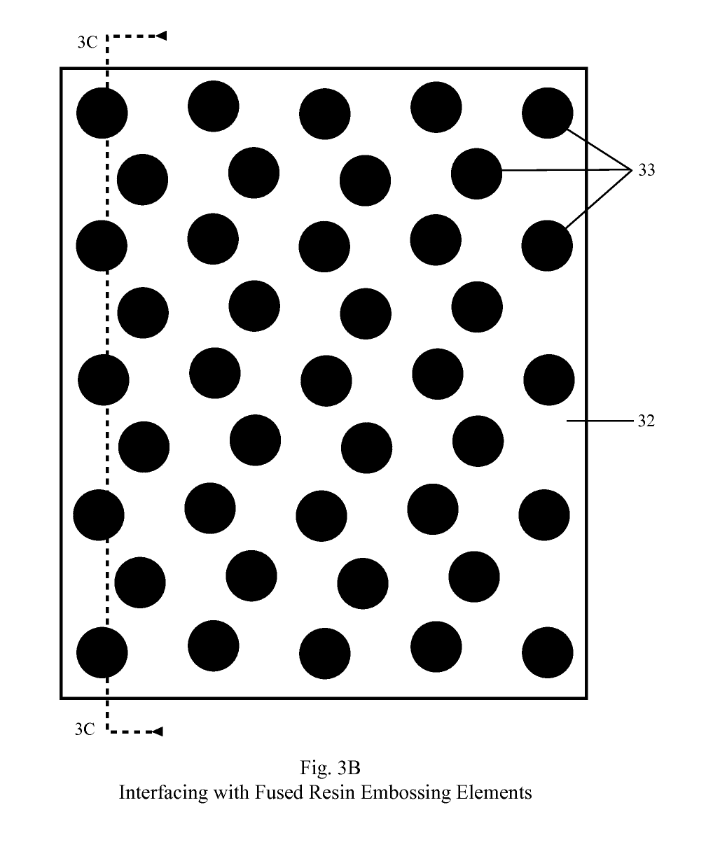

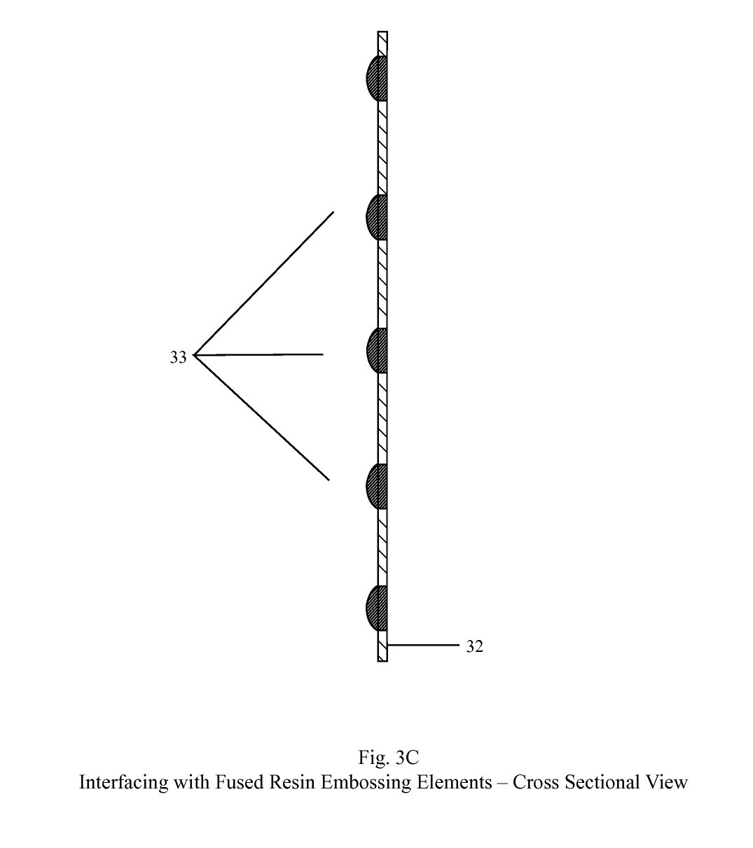

The resin material is a material that will adhere to fabric, and in the present method, will adhere to both of the interfacing and the fabric material used in the method. The resin material is typically flexible, and can be silicone or another equivalent material known in the art. The resin material can be self-curing. When using a self-curing resin, the resin can be poured over the whole matrix embossing die and then scraped off around filled embossing elements. Alternatively, the resin may be poured and filled into individual embossing elements. FIG. 3A illustrates exemplary matrix embossing die 30 with the hollow embossing elements 2 filled with resin material 31.

Step 3) placing a sheet of mesh interfacing over the resin-filled elements on the matrix component of the second die pair.

In step 3) a sheet of interfacing is placed over the resin filled elements on the matrix component of the second embossing die pair. The term “interfacing” refers to its function in the method as a material that is adhered to the inside (when worn) of the fabric of a garment. Mesh interfacing will be typically used, and is a mesh material known to one of skill in the art. The mesh interfacing may be made of synthetic fibers or any other suitable replacement material. The mesh interfacing sheet may be the same dimensions as the embossing die for ease of handling and aligning. The mesh interfacing may have an adhesive side, for aiding in adhering the mesh interfacing to the fabric sheet. If the interfacing has an adhesive side, the adhesive side must be placed facing down on top of the matrix embossing die filled with resin elements.

Step 4) pressing and heating the mesh interfacing sheet in the second die pair, so as to fuse the resin elements to the mesh interfacing sheet to form a mesh interfacing sheet with fused resin embossing elements.

Once the mesh interfacing is placed on top of the matrix embossing die with the resin embossing elements in place, it is then pressed in the embossing heat press to fuse the resin embossing elements to the mesh interfacing sheet. This is done by pressing the mesh interfacing sheet in between the embossing die pair with the hollow embossing elements of the matrix component of the die pair filled with resin material, using a pressing method as previously described in step 1.

Step 5) removing the mesh interfacing sheet with fused resin embossing elements from the second die pair.

Then, the mesh interfacing sheet with fused resin embossing elements is removed from the embossing heat press. FIG. 3B illustrates a sheet of mesh interfacing 32 with protruding resin embossing elements 33 fused to the surface. FIG. 3C shows a cross section of the interfacing sheet with fused resin embossing elements 32 shown in 3B, illustrating the three-dimensionality of protruding resin embossing elements 33.

Step 6) cutting the mesh interfacing sheet with fused resin embossing elements to a preliminary first pattern shape, wherein all of the resin embossing elements within the resin-fused mesh cut piece are whole, and none of the resin embossing elements are very near or within a marginal area around the periphery.

The next step is to cut the mesh interfacing sheet with fused resin embossing elements to a preliminary first pattern shape. The manner in which the mesh interfacing sheet with fused resin embossing elements is cut is dependent upon the type of pattern on the embossing die. As is standard practice in the art, mark the initial outlines of the preliminary first pattern shape with chalk or a similar disappearing substance on the flat side of the mesh interfacing sheet that does not contain the protruding resin embossing elements. Marking and cutting of the pattern outlines may be done either manually or with the aid of machinery as is standard practice in the art, however, marking and cutting manually may allow for more control to ensure the elimination of all resin embossing elements. The goal is to eliminate any resin (or resin embossing elements) from being too close to or within the potential seam sewing area. Resin embossing elements must be removed in toto in order to avoid resin seepage into the potential seam sewing area. If resin embossing elements are only partially removed, the remaining resin of the partial embossing element when heated will seep and fill the entire element depression in the fabric, therefore causing a conflict in the potential seam sewing area.

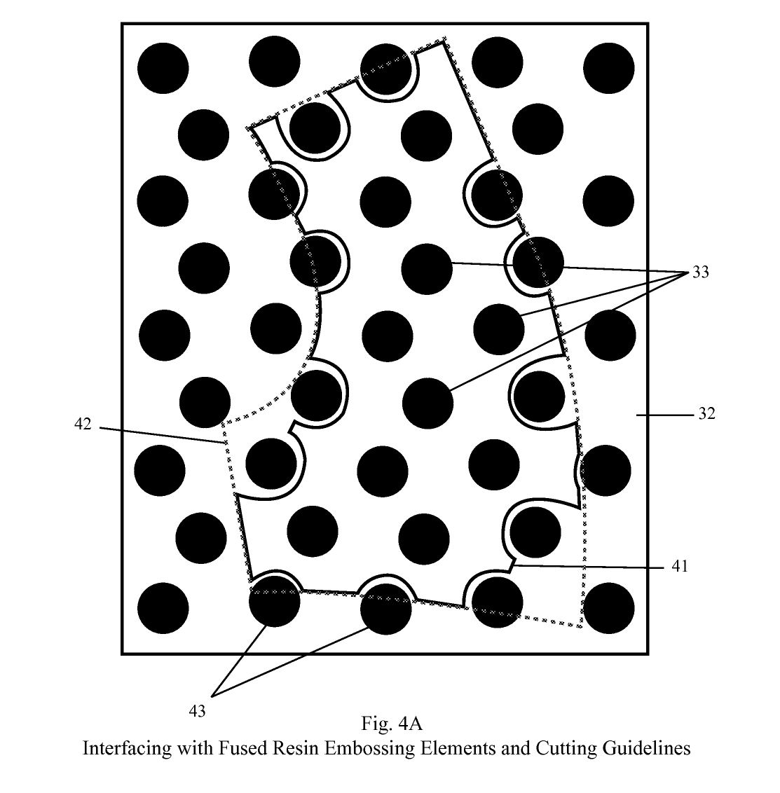

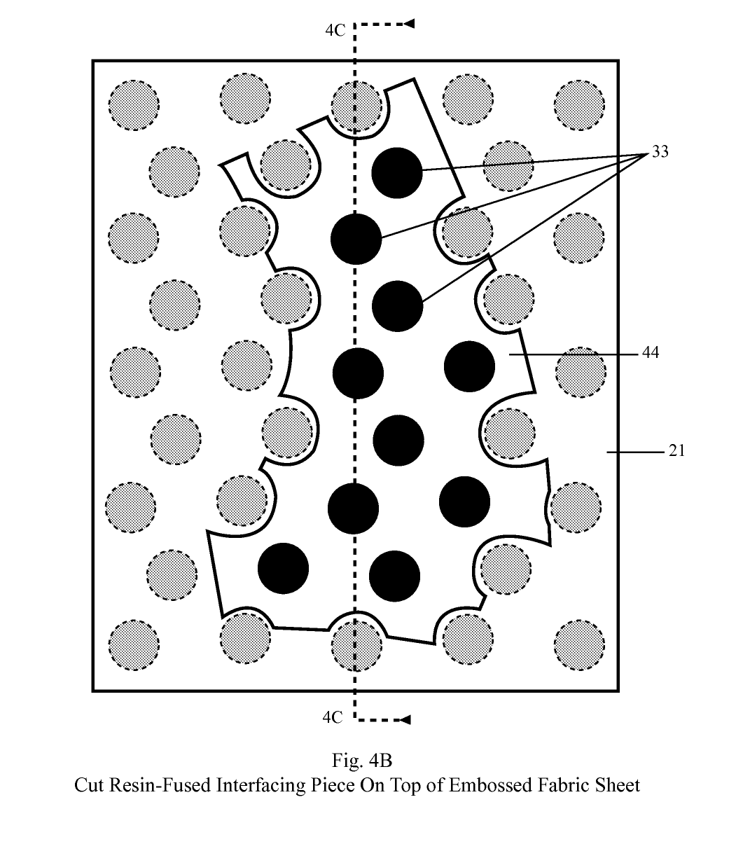

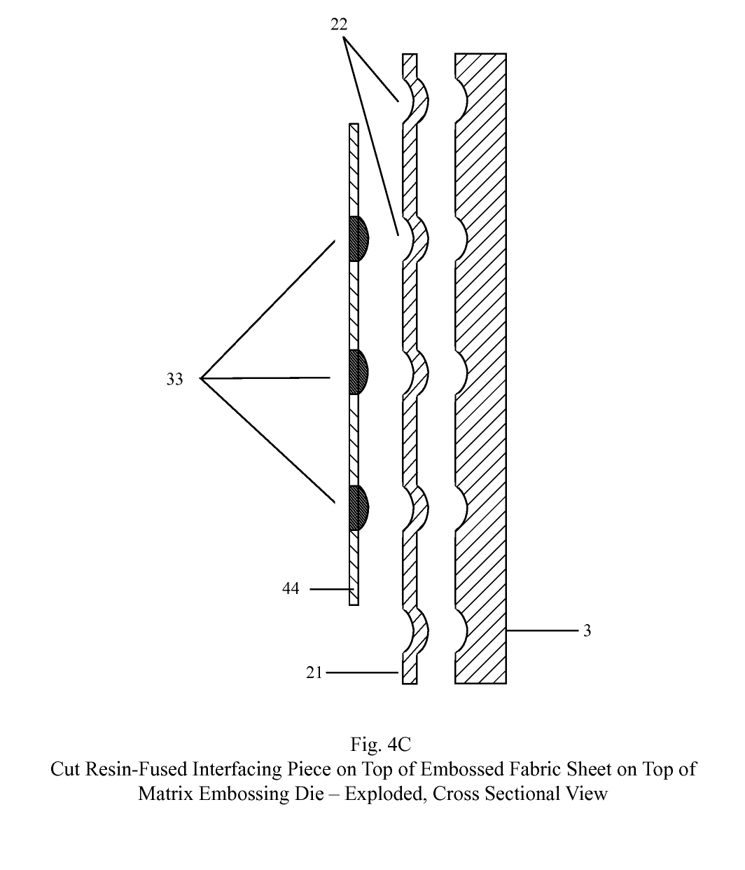

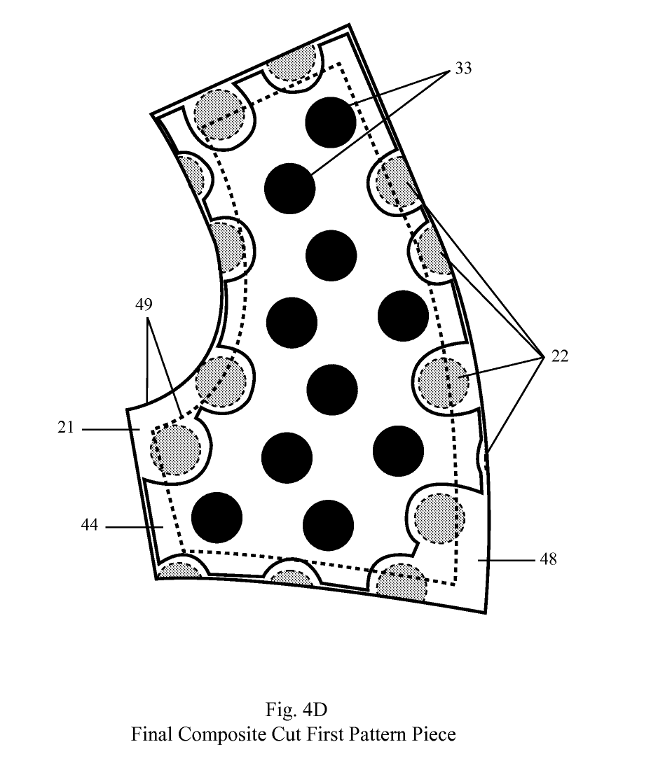

As shown in FIG. 4A, if the pattern being embossed is a pattern with singular, scattered motifs, the cut should be along the outlines of the preliminary first pattern shape markings (dotted outline 42), but modified so as to cut in and around any resin embossing elements 33, 43 that are close to, or extend over the initial outlines of the preliminary first pattern shape markings. All resin embossing elements 43 that are close to or overlap the initial outlines of the preliminary first pattern shape markings (dotted outline 42) must be removed in their entirety so that all of the remaining resin embossing elements 33 on the cut mesh piece are whole. FIG. A shows how mesh interfacing sheet 32 with fused resin embossing elements 33, 43, shown here in the exemplary scattered, polka dotted design (also depicted in FIG. 3B), is cut down to eliminate whole, or any partial, resin embossing elements 43 from the potential seam area located in the marginal periphery. The solid cut line 41 that divides and eliminates all the whole resin embossing elements 43 interfering with the potential seam sewing area modifies the initial outlines of the preliminary first pattern shape markings 42. The dotted outline 42 establishes the initial outline of the preliminary first pattern shape. The solid cut outline 41 establishes the final outline of the preliminary first pattern shape. The resin embossing elements 43 partially located within, or too close to, the initial preliminary first pattern shape outlines 42 are discarded wholly from the potential seam sewing area once the mesh is cut along the solid cut line 41. The interfacing sheet with fused resin embossing elements, after it is cut into a preliminary first pattern shape, has the shape of the solid cut line 41 indicated in FIG. 4A.

Step 7) arranging: A) the resin-fused mesh interfacing cut into a preliminary first pattern shape 44 with the resin embossing elements facing down on top of, B) the embossed fabric sheet 21 with the convex side of the elements of the fabric sheet facing down on top of, C) the matrix component of a third embossing die pair (containing the same pattern as depicted on the first and the second embossing die pair). In this arrangement, the resin embossing elements 33 on the resin-fused mesh interfacing cut into a preliminary first pattern shape 44 align with the concave elements in the embossed fabric sheet 21. One may use the first or second die pair for this step, or an additional, third die pair may be used. As all the die pairs used in this process contain the same design pattern, they may be used interchangeably, or additional pairs may be added.

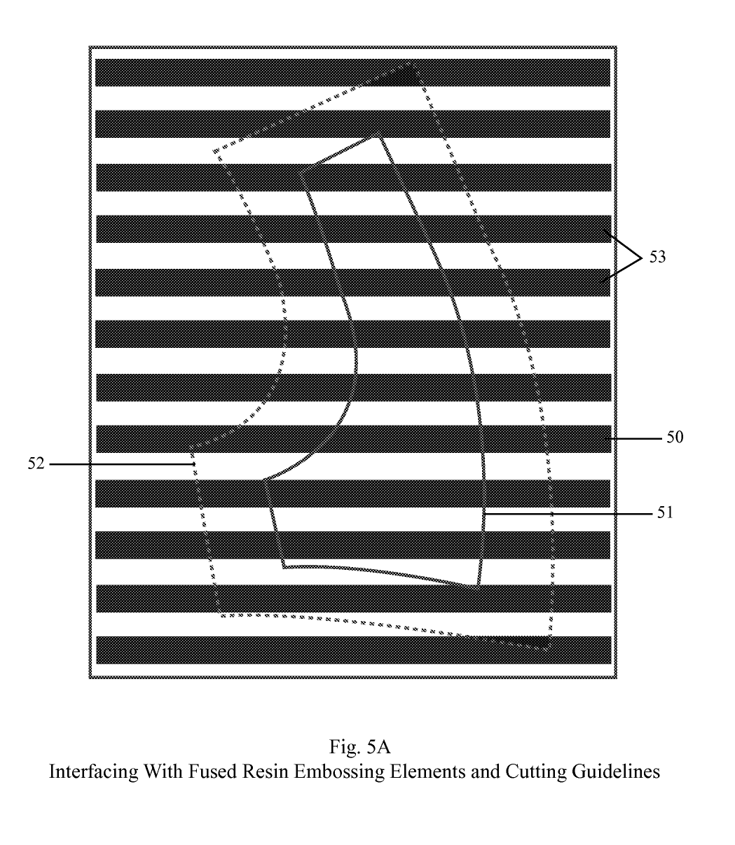

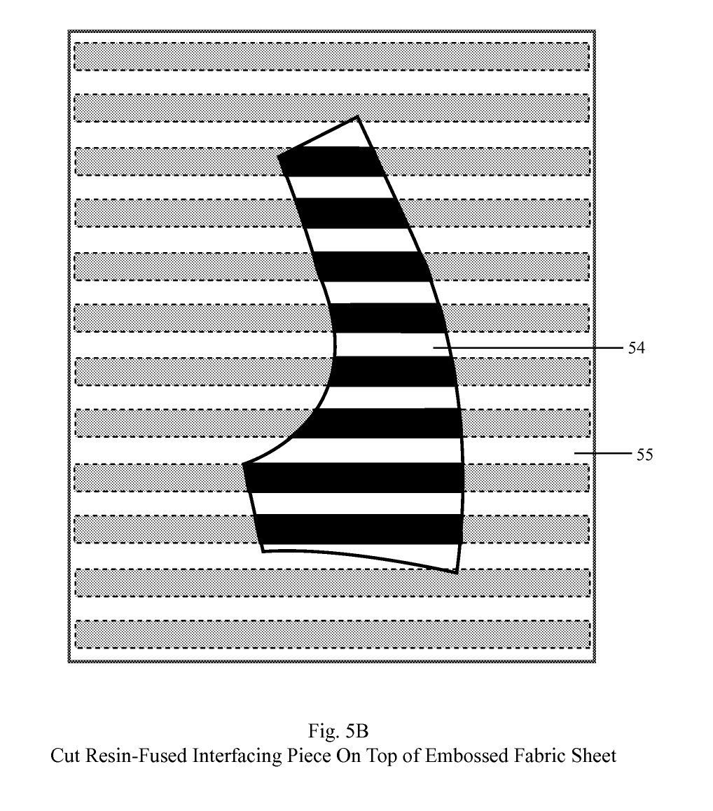

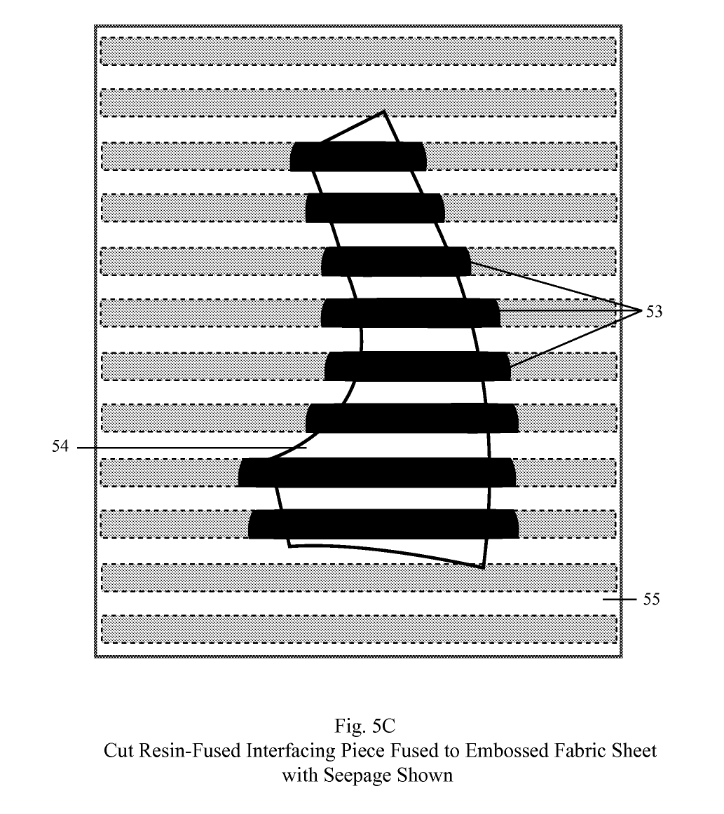

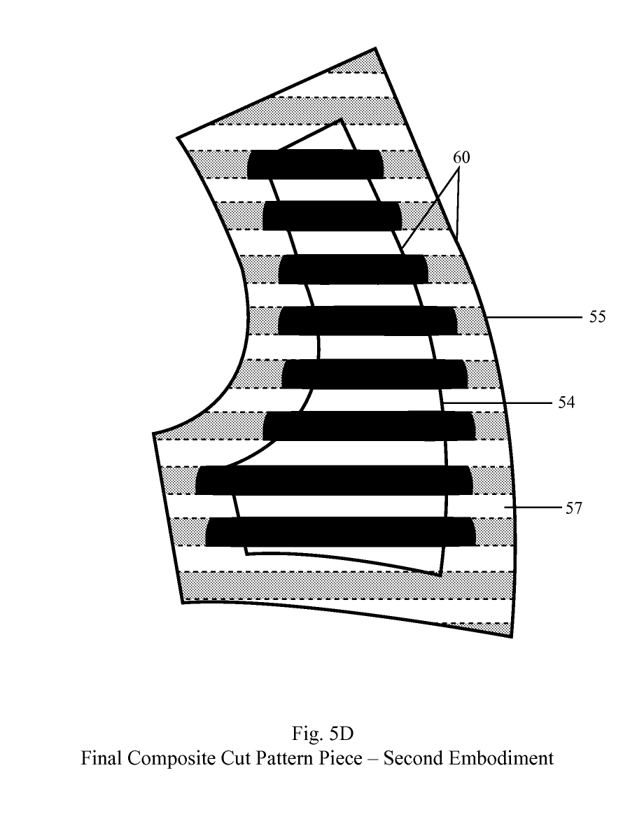

In this step, the resin-fused mesh interfacing cut into a preliminary first pattern shape 44 is arranged with the resin embossing elements 33 facing down on top of embossed fabric sheet 21 with the convex side of the fabric sheet facing down, with both being arranged on top of the matrix component of the embossing die such that the resin embossing elements 33 align with the concave elements 22 in the embossed fabric sheet 21. FIG. 4B displays the resin-fused mesh interfacing which has been cut into a preliminary first pattern shape 44 in the polka dotted design depicted in FIG. 4A overlaid on top of embossed fabric sheet 21. The matrix embossing die of the third die pair 3 is underneath fabric sheet 21 and is not visible. FIG. 4C shows an exploded, cross sectional view of FIG. 4B, and in which the matrix embossing die 3 is visible. This illustrates how: A) the convex resin embossing elements 33 on the resin-fused mesh interfacing cut into a preliminary first pattern shape 44 fit into, B) the concave elements 22 on the embossed fabric sheet 21, and overlie, C) the matrix embossing die 3. FIG. 5B shows the resin-fused mesh interfacing cut into a first pattern shape 54 in a continuous striped design (as described in the second embodiment) overlaid on top of embossed fabric sheet 55. The matrix embossing die corresponding to the embossed striped pattern is underneath embossed fabric sheet 55 and is not visible.

Step 8) heating and pressing the resin-fused mesh interfacing cut into a preliminary first pattern shape 44 to the embossed fabric sheet 21 so as to form a composite piece with resin embossing elements 33 fused into the concave elements 22 in the fabric sheet.

In this step, the resin-fused mesh interfacing cut into a preliminary first pattern shape is heated and pressed to the embossed fabric sheet 21 using temperatures and machinery known in the art such as those outlined in EP 87201464.2, so as to fuse the convex resin embossing elements 33 into the concave elements 22 in the embossed fabric sheet 21. This is done using a similar embossing die pair and/or embossing heat press as previously described.

Step 9) removing the composite piece from the embossing die pair and cutting out the composite piece to form a final first pattern piece 48 that, in its marginal area around the entire periphery of the piece, contains at least one whole or partial concave element 22 in the fabric sheet that is not filled with resin, and no resin embossing material.

The embossed fabric sheet 21, now fused with the resin-fused mesh interfacing cut into a preliminary first pattern shape 44, is removed from the embossing die pair, and becomes the composite piece. In the case of a pattern with singular, scattered motifs, the composite piece will be cut to a final first pattern piece 48 that contains at least one whole and/or partial concave element 22 that is not filled with resin in the marginal area around the entire periphery of the piece. FIG. 4D shows an example of a composite piece that has been cut to form a final first pattern piece 48 that results from the resin-fused mesh interfacing cut into a preliminary first pattern shape 44 on top of the embossed fabric sheet 21 depicted in FIG. 4B being fused together, and then cut into its final shape. There are one, or more, whole and/or partial concave elements 22 in the final first pattern piece 48 that are not filled with resin around the periphery of the piece. As a result, there is a clean marginal area 49 (delineated between the solid and dotted lines) of embossed fabric and mesh interfacing in it that does not contain any resin material along the entire outer periphery of composite final first pattern pieces to allow for sewing such final first pattern pieces to other final first pattern pieces and/or into a garment, and finishing of seams. The width of the marginal area 49 will depend upon the type of materials involved and the type of seam being sewn. A typical marginal area would have a width in the range of ¼-2.5 inches for this pattern embodiment.

An optional second layer of interfacing may be applied on top of the final first pattern piece 48 for added comfort and durability.

This process may be repeated with additional fabric sheets and additional embossing die pairs containing the same or different patterns as those used to create the first embossed fabric sheet 21. When composite resin-fused mesh interfacing and fabric embossed cut pattern pieces are finished, a clean marginal area 49 of embossed fabric and interfacing that does not contain any resin material should extend along the entire outer periphery of composite cut pattern pieces to allow for sewing and finishing of seams between composite cut final pattern pieces and/or other pattern pieces of a garment.

### Second Embodiment

In a second embodiment, the method of the invention can produce a continuous embossed pattern. Continuous patterns are known to those of skill in the art and can include, for example, stripes and plaid patterns. The continuous pattern is distinguished from a pattern with singular, separate motifs in that the elements of the continuous pattern run over a large fraction of the width or length of the pattern piece.

The steps of the second embodiment are as follows:

1) pressing a fabric sheet with a first embossing die pair having a punch component and a matrix component, wherein the embossing die pair contains a continuous pattern, to form concave/convex embossing elements therein;

2) adding resin material to substantially fill the hollow elements of the matrix component of a second embossing die pair having the same pattern as the first embossing die pair;

3) placing a sheet of mesh interfacing over the resin filled elements on the matrix component of the second die pair;

4) pressing and heating the mesh interfacing, so as to fuse resin to the mesh interfacing to form resin embossing elements therein;

5) removing the mesh interfacing sheet with fused resin elements from the second die pair;

6) cutting the mesh interfacing sheet with fused resin elements to form a first pattern shape piece;

7) arranging: A) the resin-fused mesh interfacing cut into a first pattern shape with the resin embossing elements facing down on top of, B) the embossed fabric sheet with the convex side facing down on top of, C) the matrix component of the embossing die such that the resin embossing elements on the resin-fused mesh interfacing cut first pattern shape piece align with the concave elements in the embossed fabric sheet;

8) heating and pressing the resin-fused mesh interfacing cut into a first pattern shape to the embossed fabric sheet so as to form a composite piece with resin embossing elements fused into the concave elements in the embossed fabric sheet, the heating and pressing being performed by an embossing heat press with an embossing die pair as previously described;

9) removing the composite piece from the embossing heat press and cutting out from the composite piece a final pattern piece, such that the closest distance between an edge of the final pattern piece and an edge of the resin-fused mesh interfacing cut into a first pattern shape is at least 0.5 inch.

These steps are similar to the steps of the first embodiment. However, in the second embodiment, the embossing die pair contains a continuous pattern, as opposed to singular motifs, as in the first embodiment.

As a result of this difference, step (9) defines the relative shape of the resin-fused mesh interfacing cut into a first pattern shape, which was cut in step (6), and the final pattern piece cut from the composite pattern piece in step (9). The closest distance between an edge of the final composite pattern piece and an edge of the resin-fused mesh interfacing cut into a first pattern shape is at least 0.5 inch. That is, there is a marginal region of fabric on the final composite pattern piece with no mesh interfacing. This closest difference may be, for example, at least 1, 2, or 4 inches, as appropriate for a given pattern and seam allowance.

FIG. 5D shows an example of a final composite pattern piece 57 that results from the embossed fabric sheet 55 and the resin-fused mesh interfacing cut into a first pattern shape 54 depicted in FIG. 5B being fused together (step 8) and cut (step 9). There is a marginal area 60 that allows for sewing and extra room for seepage of resin material between edges of the resin-fused mesh interfacing cut into a first pattern shape 54 and the edges of embossed fabric sheet 55. The marginal area 60 extends along the entire periphery of the embossed fabric sheet 55 and inward to the outer peripheral edge of the first pattern shape 54.

Therefore, the cutting of the first pattern shape 51 in step (6) is such as to eliminate any resin elements 53 of the continuous pattern that fall, for example, within 0.5 inches of any edges of the final pattern piece outlines 52 (see FIG. 5A). The resin elements 53 that interfere with the marginal area for sewing in a continuous design will be simply cut down in size rather than removed wholly as they are in the case of a pattern with singular, scattered motifs.

In some cases, the first pattern shape of the mesh interfacing with fused resin elements will be graded down in size and cut by, for example, 0.5 to 4 inches all around the perimeters of the shape to which the first pattern shape piece will be cut. The amount to which it is cut will depend on the size of the potential seam allowance and the desired size of the final marginal area.

The method of the present invention can be used even if there is seepage of the resin material outside of the edges of the resin-fused mesh interfacing cut into a first pattern shape. Once pressed again in the embossing heat press in step (8), the resin material will seep minimally outside of the edges of the resin-fused mesh interfacing cut into a first pattern shape and onto the embossed fabric sheet. The size of the fabric marginal area without resin material 60 can be selected such that the entire resin-fused mesh interfacing cut into a first pattern shape has been cut down in size around its entire periphery so that the resin has room to expand from heat without bleeding significantly into the seam area. FIG. 5A shows how a mesh interfacing sheet with fused resin elements 50 in an exemplary continuous, striped design formed in step (4) is cut down to eliminate resin embossing elements 53 from the expected seam area around the sheet's periphery. The solid cut line 51 that divides and eliminates resin embossing elements interfering with the seam area is a smaller version of the dotted original pattern piece marked outline 52. Portions of the resin embossing elements 53 contained within the initial marked pattern piece outlines 52 are eliminated from the seam area once the mesh interfacing is cut to the outline of 51.

Once the embossed fabric sheet fused with the resin-fused mesh interfacing cut into a first pattern shape is removed from the embossing heat press (step 9), there may be resin seepage out from beneath the mesh interfacing cut first pattern shape and into the embossed grooves on the fabric sheet. FIG. 5C illustrates what resin seepage from embossing elements 53 might look like once the resin-fused mesh interfacing cut into a first pattern shape 54 and the embossed fabric sheet 55 depicted in FIG. 5B are heated and pressed (step 8).

### Additional Embodiments

Typically, a final garment will be made of multiple (first or final) pattern pieces sewn together. Two (first or final) pattern pieces of the same or different pattern shapes can be sewn together so as to form a seam line. Typically, when sewn together, there will be no resin-filled elements within ¼ to 2.5 inches of the seam line.

The present invention encompasses products made by the above-described methods.

The structure of the (first or final) pattern pieces made by the above method will typically be as follows: The (first or final) pattern piece will include:

a fabric sheet having an inside face and an outside face, the fabric sheet cut to a final pattern shape, wherein the sheet has embossed scattered motifs that are concave toward the inside face and convex toward the outside face;

resin elements filling and bonded to at least some of the embossed motifs on the inside face of the fabric sheet, wherein all of the resin elements are whole motifs, and wherein at least one embossed motif of the fabric sheet is not filled with resin; and

a sheet of mesh interfacing covering and bonded to the resin elements and contacting at least some of the inside face of the fabric sheet between the resin elements; and

a marginal area around the periphery of the fabric sheet that is free of resin-filled elements, the marginal area providing an area wherein a seam may be sewn, so as to make a garment or part of a garment.

These fabric and mesh pattern pieces, when sewn together, will typically be used to make a garment or part of a garment that appears to have an embossed, resin-filled pattern from edge to edge, but in actuality retains a margin around the edges where there is no resin-filled pattern to allow for sewing. Embossed and resin-filled pattern pieces in this invention take into account seepage of resin material into the seam allowances of the garment and provide clean marginal areas free of resin material to allow for garments to be constructed and sewn properly. In contradistinction to existing techniques, using our method will result in a garment or part of a garment that appears to have continuous, edge-to-edge raised embossing even where there are seams. Our method permits the raised embossing elements to be very close to the visible seam edges.

It will be understood by one of skill in the art that the method of manufacture of a wide variety of embossed fabrics and completed garments is encompassed by the present invention.

I/We claim the following:

1. A method for making an embossed pattern piece intended to be sewn into a garment or part of a garment, comprising the steps of:
1) pressing a flexible material piece with a first embossing die pair having a punch component and a matrix component to form convex/concave elements in the flexible material piece, wherein the embossing die pair contains a pattern of singular, scattered motifs;
2) adding resin material to substantially fill the hollow elements of a matrix component of a second embossing die pair having the same pattern as the first embossing die pair;
3) placing a sheet of interfacing over the resin-filled elements on the matrix component of the second die pair;
4) pressing and heating the interfacing sheet in the second die pair, so as to fuse the resin embossing elements to the interfacing to form an interfacing sheet with fused resin embossing elements;
5) removing the interfacing sheet with fused resin embossing elements from the second die pair,
6) cutting the interfacing sheet with fused resin embossing elements to create a resin-fused interfacing cut into a preliminary first pattern shape, wherein all of the resin embossing elements within the resin-fused interfacing cut preliminary first pattern shape are whole, and wherein a continuous marginal area is created around the periphery that is free of resin embossing elements;
7) arranging: A) the resin-fused interfacing cut into a preliminary first pattern shape with the resin embossing elements facing down on top of, B) the embossed flexible material piece with the convex side facing down on top of, C) the matrix component of the embossing die such that the resin embossing elements on the interfacing align with the concave elements in the embossed flexible material piece;
8) heating and pressing the resin-fused interfacing cut into a preliminary first pattern shape to the embossed flexible material piece so as to form a composite piece with resin embossing elements fused into the concave elements in the embossed flexible material piece;
9) cutting out the composite piece so as to form a final first pattern piece that contains a marginal area around its periphery containing at least one whole or partial concave/convex element in the embossed flexible material piece that is not filled with resin, the marginal area having a width in the range of ¼-2.5 inches from the edge of the pattern piece.

2. The method of claim 1, wherein the resin material is silicone.

3. The method of claim 1, wherein:
the resin material is self-curing; and
step (2) comprises pouring the resin material over the whole matrix embossing die and scraping off the excess resin around filled elements.

4. The method of claim 1, wherein in after step (9), all of the concave/convex elements touching the edges of the pattern piece are not filled with resin.

5. The method of claim 1, wherein in after step (9), all of the concave/convex elements within the marginal area are not filled with resin.

6. The method of claim 1, further comprising the steps of: repeating steps (1) to (9) for a second flexible material piece and a second interfacing so as to form a second pattern piece, wherein the second pattern piece is cut to a final pattern shape that can be sewn to the final first pattern piece; and sewing the final first pattern piece to the final second pattern piece so as to form a seam there between, the seam being located in a respective marginal area of the pattern pieces.

7. The method of claim 1, wherein the flexible material piece is a fabric sheet.

8. The method of claim 1, wherein the sheet of interfacing is a mesh interfacing.

9. The method of claim 1, wherein there are no whole or partial resin filled embossing elements within the marginal area around the periphery of the piece.

10. A pattern piece made by the process of claim 1.

11. A sewn flexible material product made by the process of claim 6.

12. A method for embossing a flexible material piece, comprising the steps of:
1) pressing a flexible material piece with a first embossing die pair having a punch component and a matrix component, wherein the embossing die pair contains a continuous pattern;
2) adding resin material to the hollow elements of the matrix component of a second embossing die pair having the same pattern as the first embossing die pair,
3) placing a sheet of interfacing over the resin filled elements on the matrix component of the second die pair;
4) pressing and heating the interfacing sheet, so as to fuse resin embossing elements to the interfacing sheet;
5) removing the interfacing sheet with fused resin embossing elements from the second die pair,
6) cutting the interfacing sheet with fused resin embossing elements to a first pattern shape;
7) arranging: A) the resin-fused interfacing cut into a first pattern shape with the embossing elements facing down on top of, B) the embossed flexible material piece with the convex side facing down on top of, C) the matrix component of the embossing die such that the resin embossing elements on the interfacing align with the concave elements in the embossed flexible material piece;
8) heating and pressing the resin-fused interfacing cut into a first pattern shape to the embossed flexible material piece so as to form a composite piece with resin embossing elements fused into the concave elements in the embossed flexible material piece;
9) cutting out from the composite piece to create a final pattern piece, such that the closest distance between an edge of the final pattern piece and an edge of the resin-fused interfacing cut into a first pattern shape is at least 0.5 inch.

13. The method of claim 12, wherein the closest distance between an edge of the resin-fused interfacing cut into a first pattern shape and an edge of the final pattern piece is at east inch.

14. The method of claim 12, wherein the closest distance between an edge of the resin-fused interfacing cut into a first pattern shape and an edge of the final pattern piece is at least 2 inches.

15. The method of claim 12, wherein the closest distance between an edge of the resin-fused interfacing cut into a first pattern shape and an edge of the final pattern piece is at least 3 inches.

16. The method of claim 12, wherein the closest distance between an edge of the resin-fused interfacing cut into a first pattern shape and an edge of the final pattern piece is at east 4 inches.

17. The method of claim 12, wherein the first pattern shape of the resin-fused cut interfacing is a graded down shape relative to the shape of the final pattern piece.

18. A flexible material piece made by the process of claim 12.

19. A pattern piece, comprising:
a flexible material piece having an inside face and an outside face, the flexible material piece having a final pattern shape, wherein the flexible material piece has embossed scattered motifs that are concave toward the inside face;
resin elements filling and bonded to at least some of the embossed motifs on the inside face of the flexible material piece, wherein all of the resin elements are whole motifs, and wherein at least one embossed motif of the flexible material piece is not filled with resin; and
a sheet of interfacing covering and bonded to the resin elements and contacting at least some of the inside face of the flexible material piece between the resin elements.
